(19) United States
(12) Patent Application Publication
(10) Pub. No.: US 2018/0053150 A1
(43) Pub. Date: Feb. 22, 2018

(54) METHOD AND SYSTEM FOR FACILITATING TRANSACTION OF USED PRODUCTS

(71) Applicant: Syed Mohammad Ahsan, Piscataway, NJ (US)

(72) Inventor: Syed Mohammad Ahsan, Piscataway, NJ (US)

(21) Appl. No.: 15/488,501

(22) Filed: Apr. 16, 2017

Related U.S. Application Data
(60) Provisional application No. 62/376,403, filed on Aug. 18, 2016.

(51) Int. Cl. G06Q 10/08; G06Q 30/06; G06Q 20/10; G06K 7/10; H04L 29/06; G07C 9/00; G06K 1/00

(52) U.S. Cl. CPC G06Q 10/0836; G06Q 30/0609; G06Q 30/0623; G06Q 20/10; G06K 1/00; H04L 63/08; G07C 9/00142; G07C 9/00912; G06Q 10/087; G06K 7/10861

(57) ABSTRACT

Disclosed is a method and system that enables users to transact (buy, sell, rent or exchange) used products by facilitating secured localized delivery and/or retrieval of the products, and ensuring that transacting users are present in the geo-spatial vicinity of one another. In particular, the embodiments of the present invention propose a cost-effective transaction model for the users to transact used products. The transacting users are neither incurring inconvenience of visiting a physical store to deliver and/or retrieve the transacted products offline. Nor they will incur any cost towards shipping that most of the online ecommerce business requires.

### CROSS REFERENCE TO RELATED APPLICATION

The present application claims the priority benefits of U.S. Provisional Application No. 62/376,403, filed on Aug. 18, 2016, titled “METHOD OF TRANSACTION”, which is incorporated herein by reference in its entirety.

### TECHNICAL FIELD OF INVENTION

The present application generally relates to systems and methods for transaction, and specifically, it relates to a method and system that enables users to transact (buy, sell, rent or exchange) used products, and facilitates localized delivery and/or retrieval of the transacted used products by ensuring that the transacting users are present in the geo-spatial vicinity of one another.

### BACKGROUND

Buy, sell, rent and exchange of products between two or more parties has been around from decades, in fact from origin of human beings when human used to barter or exchange their products face to face. Now, with the technological advancements, things have changed. There are methods available to buy, sell, rent and exchange various products both new products as well resold products by the users either using offline mediums or using online platforms or marketplaces (such as EBAY®, AMAZON®) which are easily accessible by the users on their communication devices such as mobile phones or computers.

In the scenario, when the users choose to buy, sell, rent and exchange the products using the offline mediums, the users are required to visit stores that sell, buy, rent or exchange the product. Such in-store visit to buy, sell, rent or exchange any product by the users require the users to spend lot of user's time to physically visit such stores and find out if the products they wish to buy, sell, rent or exchange are actually accepted by the store or not, many a times, people end up wasting time when they are informed that the store doesn't accept the products they wish to transact. Thus, such offline medium for transaction is very time consuming and can be expensive when the users end up without any successful deal with the stores.

Again, in the scenario, where the users intent is to use popular online platforms or marketplaces such as EBAY®, AMAZON® for transactions, such as to buy, sell, rent or exchange of the products. The most common problem the users face is they are required to incur additional shipping cost that the online platforms impose on each transaction the user does. The users are required to pay shipping cost towards the product they wish to sell or buy when the user ships the product to prospective buyer or the platform ships the product to the user at user location. Also, shipping of such products from seller to the buyer takes lot of time.

Further, such online ecommerce or marketplaces are mainly designed for products (newly listed products) to be sold once to an end user. These are not actually designed to handle the products that change hands one or more times over the life of the product. Although, some of online marketplaces or ecommerce facilitate sell and buy of products that are supposed to be relisted on the platform again, in such platforms, when a specific product is sold once, the listing of the product disappears and the product becomes no longer available for sell until the buyer (i.e., prospective seller) re-lists the same product for sell in the platform. Such sell entails the user to retype the product information again, provide images etc. and the user have to go through a cumbersome standard process of listing or relisting the product for sell on the platform.

Such online platforms although facilitate the users to buy or sell the products, these platforms, typically focus mostly on facilitating deals between sellers and end users interested in buying the products and often do not cater to various needs or desires of the users.

In brief, although existing offline medium and the online platforms facilitates the users to buy, sell, rent or exchange the products, however they are relatively expensive, time consuming and inconvenient.

Thus, in the light of the above-mentioned background art, it is evident that, there is a need for a method and system that would facilitate the users to transact one or more products in a cost effective and convenient way.

The proposed system and method intends to resolve the inefficiency in the online and offline systems discussed above, by presenting a new method or system that enables users to transact (buy, sell, rent or exchange) products particularly used products by facilitating localized delivery and/or retrieval of the products by ensuring that transacting users are present in the geo-spatial vicinity of one another.

### BRIEF SUMMARY

Before the present systems and methods, enablement are described, it is to be understood that this application is not limited to the particular systems, and methodologies described, as there can be multiple possible embodiments which are not expressly illustrated in the present disclosures. It is also to be understood that the terminology used in the description is for the purpose of describing the particular versions or embodiments only, and is not intended to limit the scope of the present application.

An objective of the present invention is to provide a method and system that enables users to transact (buy, sell, rent or exchange) used products, and facilitates localized delivery or retrieval of the transacted used products by ensuring that the transacting users are in the geo-spatial vicinity of one another.

Another objective of the embodiments herein is to provide a method and system that would facilitate the users to transact one or more products in a cost effective and convenient way.

Another objective of the embodiments herein is to provide a cost effective and hybrid transacting model for the users to transact used products and that would help overcome the inefficiencies present in online and offline systems existing in the art.

According to an aspect of present invention, a method for facilitating one or more users to transact one or more used products, and enabling localized delivery and/or retrieval of the product by ensuring that transacting users are in the geo-spatial vicinity of one another is provided. The method includes receiving, one or more user related information, from each of the users by an application server with one or more databases for creation of a user account, and storage of the one or more user related information in the one or more databases; allowing, each of the users to securely login to the user account using a user communication device communicatively coupled with the application server; displaying, a used product listing to each of the user over the user communication device by the application server based on the one or more user related information stored in the one or more databases, wherein the display of the used products listing may selectively be initiated by the user using a search query consisting of one or more information associated with the used products; selecting, a specific used product from the used product listing displayed over the user communication device by the user for transaction; transferring payment, for the selected used product selected for transaction by the user using the user communication device communicatively coupled with the application server.

According to the aspect of present invention, the method further includes generating and transmitting, by the server at least one of: an electronic locker related information associated with an electronic locker with one or more image capturing means configured within the geo-spatial vicinity of the user, wherein the electronic locker related information is generated and transmitted based the on the one or more user related information stored in the one or more databases; a user authentication code for authorizing the user to securely access the electronic locker configured within the geo-spatial vicinity of the user and to enable the localized delivery and retrieval of the selected used product to and from the electronic locker; and a Used Product Code (UPC) associated with the selected used product, wherein the generation of the Used Product Code (UPC) identifying the selected used product is accomplished during the transaction request from the user. According to the embodiment, the method further includes step of prompting the user to enter the Used Product Code (UPC) associated with the selected used product and labeled thereon when the user transacts the selected used product next time.

According to the aspect of present invention, the method further includes labeling, the selected used product, with the Used Product code (UPC) by the user before delivering the selected used product into the electronic locker; authenticating, the localized delivery and/or retrieval of the selected used product to and from the electronic locker by the user using the user authentication code to complete the transaction of the selected used product; and recordation of one or more user activities in and around the electronic locker by the image capturing means; and reviewing, the selected used product during or after transaction by the user using the Used Product Code (UPC) associated with the selected used product and labeled thereon, wherein the labeling, and the reviewing facilitate in managing an inventory of the used products stored in the electronic locker.

According to another aspect of present invention, a system for facilitating one or more users to transact one or more used products, and enabling localized delivery or retrieval of the one or more used product by ensuring that the one or more users are in geo-spatial vicinity of one another is provided. The system includes an application server including one or more databases, wherein the server is communicatively coupled to a user communication device associated with each of the one or more users; an electronic locker configured within the geo-spatial vicinity of the user for storage of the used products and enabling the localized delivery and/or retrieval of the used product to and from the electronic locker; and one or more image capturing means associated with the electronic locker for recordation of one or more user activities in and around the electronic locker.

According to the aspect of present invention, the system further includes a web service coupled to the application server and having associated software application accessible by the user over the user communication device, wherein the web service of the server accessible by the user functions to: receive one or more user related information, from each of the users for creation of a user account and storage into the one or more databases associated with the application server; allow, each of the users to securely login to the user account using the user communication device communicatively coupled with the application server; display, a used product listing to each of the user over the user communication device based on the one or more user related information stored in the one or more databases, wherein the display of the used products listing may selectively be initiated by the user using a search query consisting of one or more information associated with the used products; enable the user with selection of a specific used product from the used products listing displayed over the user communication device for transaction.

According to the aspect of present invention, the web service of the server accessible by the user further functions to: enable the user to transfer payment, for the selected used product for transaction using the user communication device; generate and transmit at least one of: an electronic locker related information associated with the electronic locker, wherein the electronic locker related information is generated and provided based the on the one or more user related information stored in the one or more databases; a user authentication code for authorizing the user to securely access the electronic locker and enable the localized delivery and retrieval of the selected used product to and from the electronic locker; and a Used Product Code (UPC) associated with the selected used product, wherein the generation of the Used Product Code (UPC) identifying the selected used product is accomplished during the transaction request from the user.

Additional objects and aspects of the present invention would appear and become clear as the detail description proceeds with the accompanying drawings.

### BRIEF DESCRIPTION OF THE DRAWINGS

The foregoing summary, as well as the following detailed description of preferred embodiments, is better understood when read in conjunction with the appended drawings. There is shown in the drawings example embodiments, however, the application is not limited to the specific system and method disclosed in the drawings.

FIG. 1-FIG. 2 illustrates an overview of a system for facilitating users to transact used products using an internet based web service or an optional downloadable app on a user communication device, in accordance with an embodiment of the present invention.

FIG. 3 illustrates users in the vicinity of one another within a specific geo-location, in order to be able to explore the web services offered by the system shown in FIG. 1, in accordance with the embodiment of the present invention.

FIG. 4 illustrates a block diagram representing an electronic locker configured for enabling users within the geo-spatial vicinity of one another to locally deliver and/or retrieve the used products, in accordance with the embodiment of the present invention.

FIG. 5A-5B illustrates method steps facilitating users to transact one or more used products using the system of FIG. 1, in accordance with the embodiment of the present invention.

FIG. 6 illustrates an exemplary implementation of the system of FIG. 1, in the field of education, where the users within geo spatial vicinity of one another are enabled to buy or sell or rent or exchange one or more used books, in accordance with an embodiment of the present invention.

FIG. 7A-7B illustrates the electronic locker in a locked state and an unlocked state, respectively, in accordance with the embodiment of the present invention.

FIG. 8A-8E illustrates example web pages showing some of method steps the users need to follow to buy or sell or rent or exchange the use books.

FIG. 9A-9B illustrates detailed method steps facilitating the users to buy or sell or rent or exchange the used books using the system of FIG. 6, in accordance with the embodiment of the present invention.

### DETAILED DESCRIPTION

Some embodiments, illustrating its features, will now be discussed in detail. The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise. Although any methods, and systems similar or equivalent to those described herein can be used in the practice or testing of embodiments, the preferred methods, and systems are now described. The disclosed embodiments are merely exemplary.

The method and system, as will be described below, is a unique method and system for facilitating one or more users to transact one or more used products, and enabling localized delivery and/or retrieval of the used product by ensuring that transacting users are in the geo-spatial vicinity of one another.

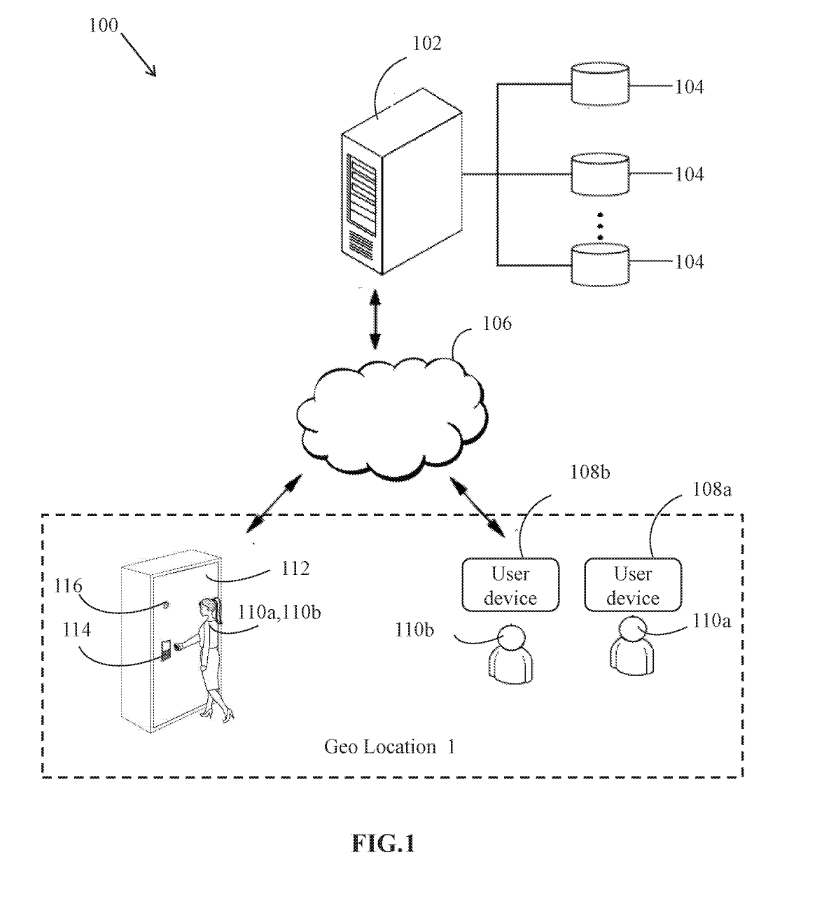

The various features and embodiments of the method and system for facilitating users to transact used products, and enabling localized delivery and/or retrieval of the used product by ensuring that transacting users are in the geo-spatial vicinity of one another are explained in conjunction with the description of FIGS. 1-9.

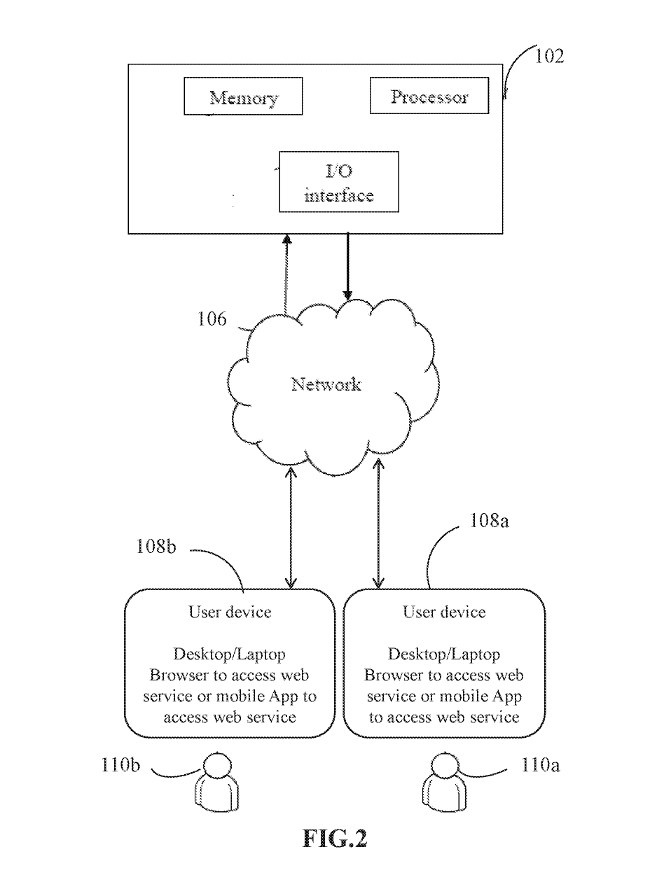

Referring to FIG. 1-FIG. 2, there is shown an application server 102 with one or more databases 104. The server 102 receives one or more user related information from users 110a, 110b when the users 110a, 110b sign up with the server 102 to register them or create their accounts. The server 102 stores all the user related information received from the users 110a, 110b in the databases 104. Once registered, the server 102 allows the registered users 110a, 110b to sign into their accounts. The user related information may preferably include a username, a password, an address associated with the users 110a, 110b, an email address, a telephone number, academics related information associated with the users 110a, 110b, profession related information associated with the users 110a, 110b, and preferred interests of the users 110a, 110b.

The server 102 is configured to provide a web service as a result of software application or set of instructions residing on at least one memory unit executable by one or more processors configured therein. The web services provided by the server 102 is accessible by users 110a, 110b over user communication devices 108a, 108b respectively either through a website coupled to the server 102 using I/O user interface provided on the website or optionally using a downloadable application that the users 110a, 110b can download on their communication devices 108a, 108b. The users 110a, 110b will preferably be using a web browser to access the website. The users 110a, 110b are able to communicate with the server 102 via the website or the app using their communication devices 108a, 108b capable of connecting to internet 106.

It should be noted that the term “Internet” is intended to encompass similar systems as well (i.e., World Wide Web or “www”) comprising the capability to communicate and access information through a communication network 106. Examples of types of the communication network 106 include, but are not limited to a local area network, a wide area network, a radio network, a virtual private network, an internet area network, a metropolitan area network, a satellite network, Wi-Fi, Bluetooth Low energy, a wireless network, and a telecommunication network. Examples of the telecommunication network include, but are not be limited to a global system for mobile communication (GSM) network, a general packet radio service (GPRS) network, third Generation Partnership Project (3GPP), an enhanced data GSM environment (EDGE) and a Universal Mobile Telecommunications System (UMTS). The present invention should not be limited in its communication nomenclature. Similarly, the communication devices 108a, 108b associated with the users 110a, 110b include, but are not limited to a cell phone, a smart phone, a cellular phone, a cellular mobile phone, a personal digital assistant (PDA), a laptop, PC, and a tablet computer.

The server 102 is able to present the web services to the users 110a, 110b in the form of textual and visual content presented in preformatted modules and sub modules that reside in one or more databases 104 and are dynamically generated and presented to the users 110a, 110b over their communication devices 108a, 108b to make the user's experience as excellent as possible. The web services accessible over the user communication devices 108a, 108b enables the users 110a, 110b to transact one or more used products.

The term ‘transact’ as used herein in this disclosure, denotes to an act of ‘buying’ or ‘selling’ or ‘renting’ or ‘exchanging’ any used product. The term ‘used product’ as described herein may include any product that change hands from one user to another one or more times over the life of the product for example, but not limited to books, furniture items, clothing, or any other products. The terms, ‘product’ or ‘used products may be interchangeably used throughout the description, similarly, the term, ‘transact’ or ‘buy’ or ‘sell’ or ‘rent’ or ‘exchange may also be interchangeably used throughout the description, the person skilled in the art should envision such uses to be synonymous use of terms.

The registered users 110a, 110b may be allowed to login to their account and access the web services offered by the server 102 over the user communication devices 108a, 108b. According to another embodiment, unregistered users may also be allowed to navigate through the web services as a guest and can then later register their account with the server 102 to become a registered user. Once the users 110a, 110b login to their account, the users 110a, 110b are presented with a used product listing over their communication devices 108a, 108b. The display of the used product listing to the users 110a, 110b may be automatic or in sync based on the user related information stored in the databases 104, or optionally the users 110a, 110b may enter one or more search queries to filter the list to get desired list of products they wish to transact (buy or sell or rent or exchange). The users 110a, 110b may use one or more information associated with the used products within their search queries to obtain the fruitful results for their search. The information associated with the used products may preferably include but not limited to a physical condition of the used product, a manufacturing year, a publication version. For example, if the user 110a, or 110b wishes to sell a specific used book then he/she can simply key in book's physical condition, publication year or year of edition, author's name etc in his/her search query and filter the provided list of the used product (specifically list of books) and get desired list of books, which the user 110a or 110b is allowed to sell on the platform.

The web service will further enable the users 110a, 110b to select a specific used product from the used products listing displayed over the user communication devices 108a, 108b for transaction (may be for buying or selling). The web service then enables the users 110a, 110b to complete transaction by allowing the users 110a, 110b to transfer payment towards the transaction.

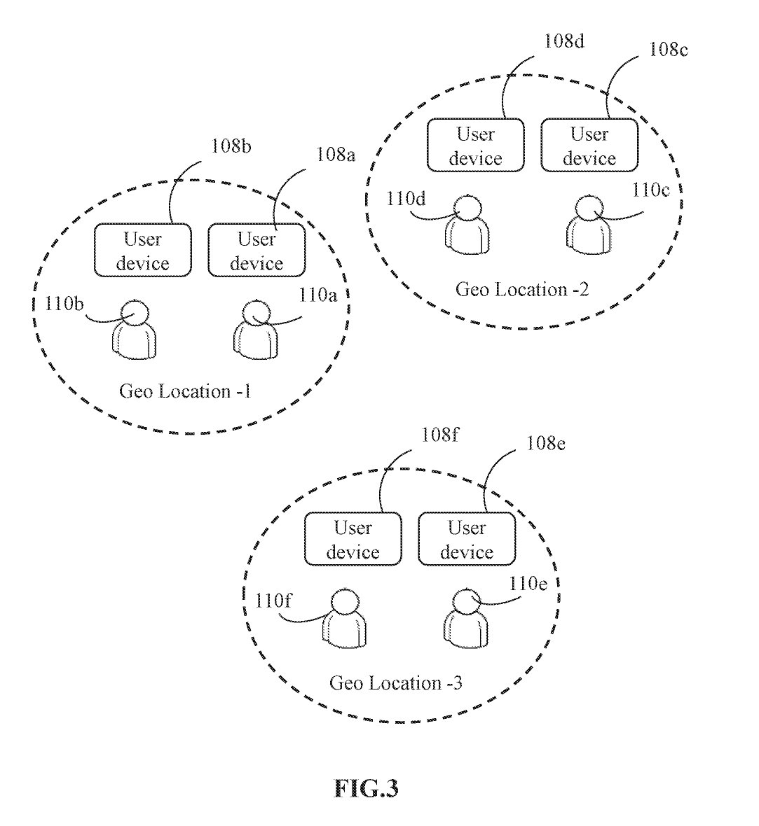

As an essence of the present invention, the server 102 or the web service allows the users 110a, 110b within geospatial vicinity of one another from a selected geo location to transact (buy or sell or rent or exchange) using the web service, as shown in FIG. 3. In this scenario, the web service allows the users 110a, 110b or the users 110c, 110d or the users 110e, 110f within the same geo location, namely, geo location-1, geo location-2, geo location-3, respectively to firstly select predefined categories of products the server 102 or web service allows for transaction in that specific geo locations and then complete the transaction.

The system 100 of present invention facilitates localized delivery and/or retrieval of products to and from one or more electronic lockers 112 configured in the specific geo location area near the vicinity of the users 110a, 110b or the users 110c, 110d or the users 110e, 110f in the specific geo location, namely geo location-1, geo location-2, geo location-3. According to the embodiment of the present invention, the verification whether the users 110a, 110b transacting are within the geo spatial vicinity of one another or not is based on the user related information stored in the databases 104. In some other embodiments, GPS locations of the users 110a,110b transmitted by the user's communication devices 108a,108b or use of any other suitable methods can also be used or combined with the user related information stored in the database 104 to ensure the users 110a,110b transacting are within the geo-spatial vicinity of one another.

The server 102 generates and provides locker related information associated with an electronic locker 112 to the users 110a, 110b. The electronic locker related information comprises of a location information associated with the electronic locker 112, and a locker identification number associated with the electronic locker 112 configured within the geo-spatial vicinity of the users 110a,110b. The electronic locker related information is generated and transmitted to the users 110a, 110b based the on the user related information stored in the databases 104. The locker related information helps the transacting users 110a, 110b to easily locate the locker 112 where they can deliver or drop the transacted product (sold or rented) and/or retrieve or pick up the used product that they transacted (preferably bought or exchanged). The locker related information may preferably be transmitted to the transacting users 110a, 110b via SMS, email, and push message over the app and so on.

The server 102 further generates and provides a user authentication code for authorizing the users 110a, 110b to securely access the electronic locker 112, and enable the localized delivery and/or retrieval of the selected used product to and from the electronic locker 112. The user authentication code may comprise of numeral, alphabet or alpha numeral code that uniquely identifies the transacting users 110a,110b and are transmitted to the transacting users 110a,110b preferably via SMS, email, and push message over the app and so on.

The server 102 further generates and provides a Used Product Code (UPC) associated with the selected used product, the generation of the Used Product Code (UPC) identifies the selected used product being transacted. The Used Product Code (UPC) according to preferred embodiment is needed during the first transaction request (preferably sell or exchange or rent request) from the user i.e, when the product is sold or exchanged or rented for the first time, once the product receives the UPC code, it then continues to act as identity for the product. The Used Product code (UPC) may comprise of numeral, alphabet or alpha numeral code.

The system 100 of present invention necessitates the users 110a,110b to label the selected used product (sold or exchanged or rented) with the Used Product code (UPC) before delivering the selected used product into the electronic locker 112. The Used Product Code (UPC) helps the users 110a, 110b to review or provide remarks on the used product bought or rented or exchanged. The Used Product Code (UPC) also helps the web services to authenticate or audit the transactions made by the users 110a, 110b and manage an inventory of the products stored in the electronic locker 112. The UPC may be transmitted to the transacting users 110a, 110b via SMS, email, push message over the app and so on, if the UPC is not already available labeled on the product intent to be transacted.

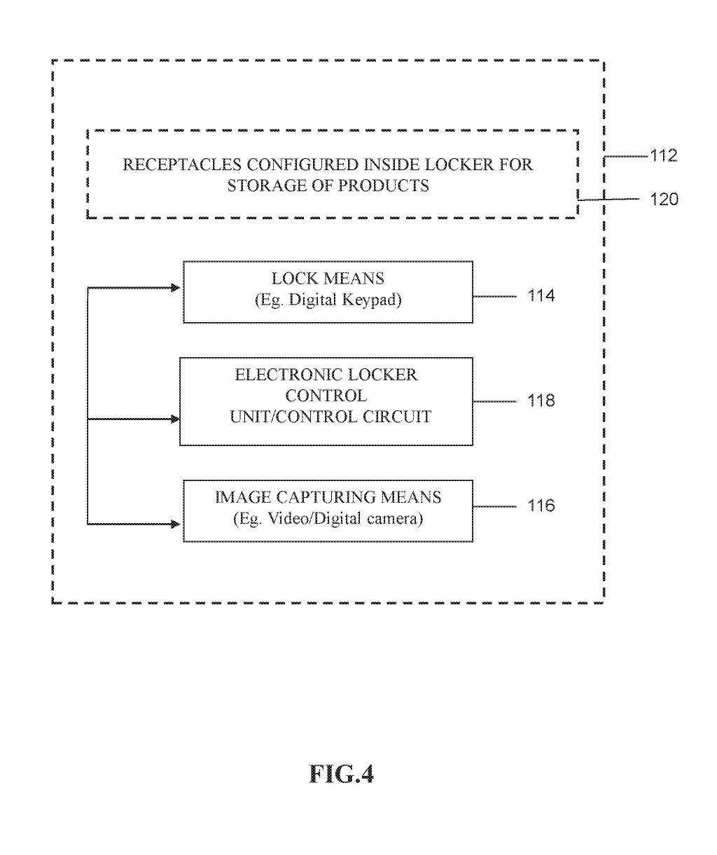

Referring to FIG. 1 in conjunction with FIG. 4, the electronic locker 112 is preferably provided with a lock means 114, and image capturing means 116 with some electronic locker control unit/control circuitry 118 operationally coupled to the lock means 114 and/or the image capturing means 116. The locker 112 can be suitably designed or constructed for secure storage of the products inside. The locker 112 would preferably facilitate single door accessibility. The single door would either be provided with a single panel or two panels functioning together which is unlocked when the users 110a, 110b enter a valid authentication code or access code. The locker 112 shown illustrated in FIG. 1 has a single door panel. According to an embodiment, the locker 112 may be designed to have a plurality of shelves strategically configured inside and spaced apart from each other to provide a plurality of receptacles 120 for receiving the products. The shelves may preferably have some identification indicia related to each of the shelves, for example, a number or name assigned to each of the shelves.

The lock means 114 configured onto the locker 112 may preferably include but not limited to a digital keypad (as shown illustrated) commercially available. According to some other embodiments, the lock means 114 may be configured to be electro-magnetically controlled using some electromagnetic locks, or even the lock means 114 may be configured to be manually controllable using a physical key. In such embodiment, the physical key would preferably be stored in a secure place and be made accessible electronically. Further, according to another embodiment, the lock means 114 may be configured to be wirelessly controllable using wireless technologies conventionally known in the art. The lock means 114 enable the users 110a, 110b to authenticate them before allowing the users 110a, 110b for localized delivery and/or retrieval of the products to and from the electronic locker 112.

The one or more image capturing means 116 configured onto the locker 112 may preferably include but not limited to a digital camera, or a video camera. The image capturing means 116 records one or more user activities in and around the electronic locker 112. The user activities may relate to the activities of the registered users 110a, 110b having account with the server 102 or activities related to unregistered users (non account holder). The activities of the registered users 110a, 110b may preferably be delivery and/or retrieval of the product to and from the electronic locker 112, theft or vandalism of the products stored in the electronic locker 112. The activities of the unregistered users may preferably be theft or vandalism related activities for the products stored in the electronic locker 112.

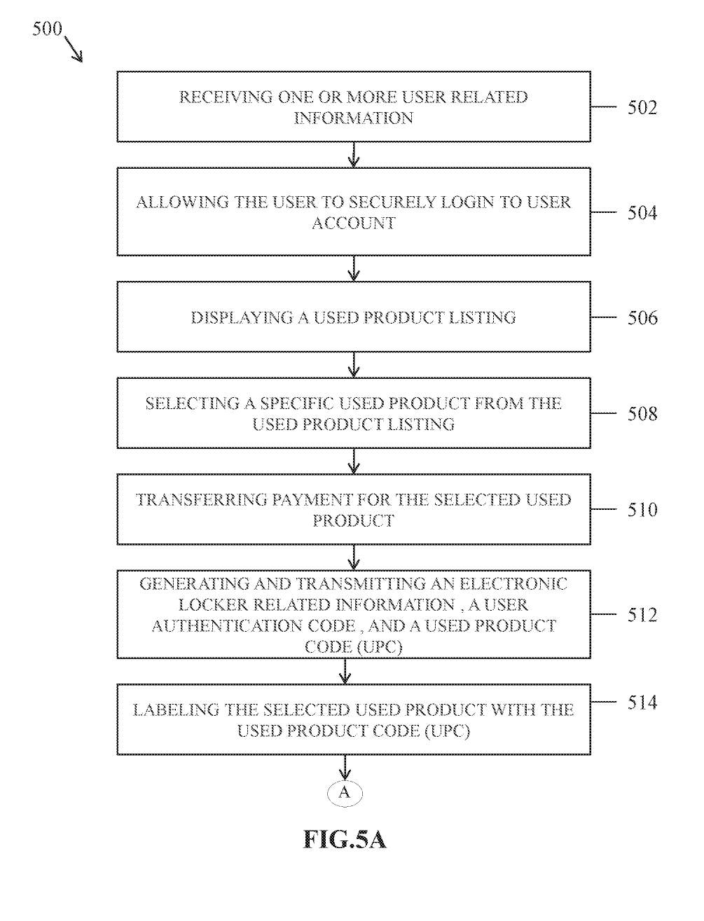

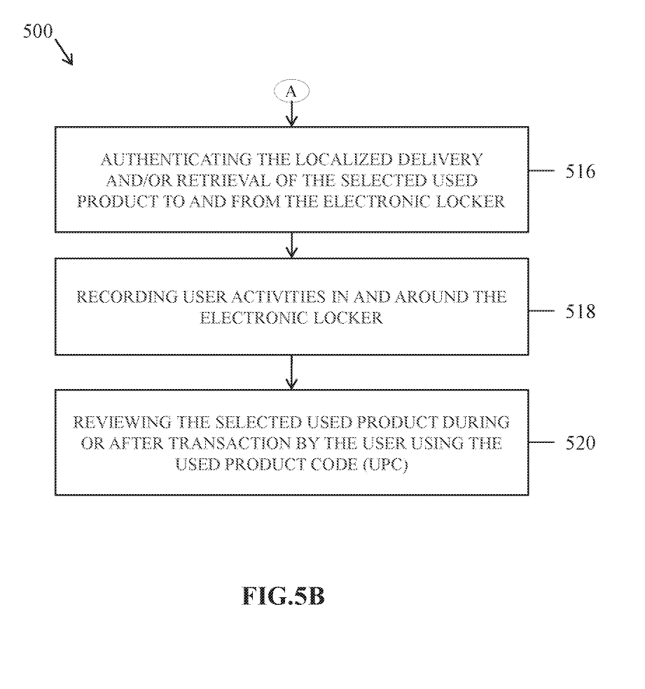

Referring to FIG. 5A-5B illustrates method steps 500 facilitating users to transact one or more used products using the system of FIG. 1 described above. As shown, the method starts at step 502 which describes a step of receiving one or more user related information by the application server 102 from the users 110a, 110b. The server 104 includes one or more databases 104 for storage of the user related information and for storage of the user accounts registered with the server 102. The user related information preferably includes a username, a password, an address associated with the users 110a, 110b, an email address, a telephone number, academic related information associated with the users 110a, 110b, profession related information associated with the users 110a, 110b, and preferred interests of the users 110a, 110b. Flow then proceeds to step 504.

The step 504 describes a step of allowing the users 110a, 110b to securely login to their user accounts using the user communication devices 108a, 108b communicatively coupled with the application server 102. Flow then proceeds to step 506.

The step 506 describes a step of display of a used product listing to the users 110a,110b over the user communication devices 108a, 108b by the application server 102 based on the user related information stored in the databases 104. The step 506 further describes the possibility of filtering the displayed used product listing by the users 110a, 110b. The users 110a, 110b may be enabled to selectively initiate a search query using one or more information associated with the used products to filter the results displayed in the list of used product and obtain more fruitful results. The information associated with the used product preferably includes but not limited to a physical condition of the used product, a manufacturing year, a publication version. Flow then proceeds to step 508.

The step 508 describes a step of selection of a specific used product from the used product listing displayed over the user communication devices 108a, 108b by the users 110a, 110b for transaction (buy or sell or rent or exchange). Flow then proceeds to step 510.

The step 510 describes transfer of payment for the selected used product for transaction by the users 110a, 110b. The users 110a, 110b are enabled to transfer or remit payment to complete transaction using the user communication devices 108a, 108b communicatively coupled with the application server 102. Flow then proceeds to step 512.

The step 512 describes a step of generating and transmitting, by the server 102 electronic locker related information associated with an electronic locker 112 with one or more image capturing means 116 configured within the geo-spatial vicinity of the users 110a, 110b. The electronic locker related information is generated and transmitted based the user related information stored in the databases 104. The electronic locker related information comprises a location information associated with the electronic locker 112, and a locker identification number associated with the electronic locker 112 configured within the geo-spatial vicinity of the users 110a,110b. The locker related information helps the transacting users 110a,110b to easily locate the locker 112 where they can deliver or drop the transacted product (sold or rented) and/or retrieve or pick up the used product that they transacted (preferably bought or exchanged). The locker related information may be transmitted to the transacting users 110a, 110b via SMS, email, and push message over the app and so on.

The step 512 further describes generating and transmitting, by the server 102 user authentication code for authorizing the users 102a,102b to securely access the electronic locker 112 configured within the geo-spatial vicinity of the users 110a,110b and to enable the localized delivery and/or retrieval of the selected used product to and from the electronic locker 112. The user authentication code may comprise of numeral, alphabet or alpha numeral code that uniquely identifies the transacting users 110a, 110b and are transmitted to the transacting users 110a, 110b via SMS, email, push message over the app and so on.

The step 512 further describes generating and transmitting, by the server 102 a Used Product Code (UPC) associated with the selected used product, wherein the generation of the Used Product Code (UPC) identifying the selected used product is accomplished during the transaction request from the user. The Used Product code (UPC) may comprise of numeral, alphabet or alpha numeral code. According to an embodiment, if the used product being transacted by the users 110a,110b already embody or have the UPC code on it, then the server 102 may not be generating the UPC for the product rather transacting user will be prompted to enter the Used Product Code (UPC) associated with the selected used product and labeled thereon. The UPC codes are uniquely generated to identify used products and once assigned to a product is intact for that product so during the next transaction the user may not receive the UPC code, rather the users 110a, 110b would be asked to enter the UPC provided on the product being transacted. Flow then proceeds to step 514.

The step 514 further describes labeling of the selected used product, with the Used Product code (UPC) by the user before the user delivers the selected used product into the electronic locker 112. The labeling of the product is mainly during a sell or exchange transaction. The Used Product Code (UPC) helps the web services to authenticate or audit the transactions made by the users 110a, 110b and manage an inventory of the products stored in the electronic locker 112. Flow then proceeds to step 516.

The step 516 describes a step of authenticating, the localized delivery and/or retrieval of the selected used product to and from the electronic locker 112 by the users 110a, 110b using the user authentication code received from the server 102 to complete the transaction of the selected used product. Flow then proceeds to step 518.

The step 518 describes a step of recordation of one or more user activities in and around the electronic locker 112 by the image capturing means 116. The user activities may relate to the activities of the registered users 110a, 110b having account with the server 102 or activities related to unregistered users (non account holder). The activities of the registered users may preferably be delivery and/or retrieval of the product to and from the electronic locker 112, theft or vandalism of the products stored in the electronic locker 112. The activities of the unregistered users may be theft or vandalism of the products stored in the electronic locker 112 that may be recorded by the image capturing means 116. Flow then proceeds to step 520.

The step 520 describes a step of reviewing the transacted used product during or after transaction (after the user has bought or exchanged the used product) by the user using the Used Product Code (UPC) associated with the used product and labeled thereon. The steps of reviewing also facilitate the web service in managing the inventory and quality of the used products stored in the electronic locker 112.

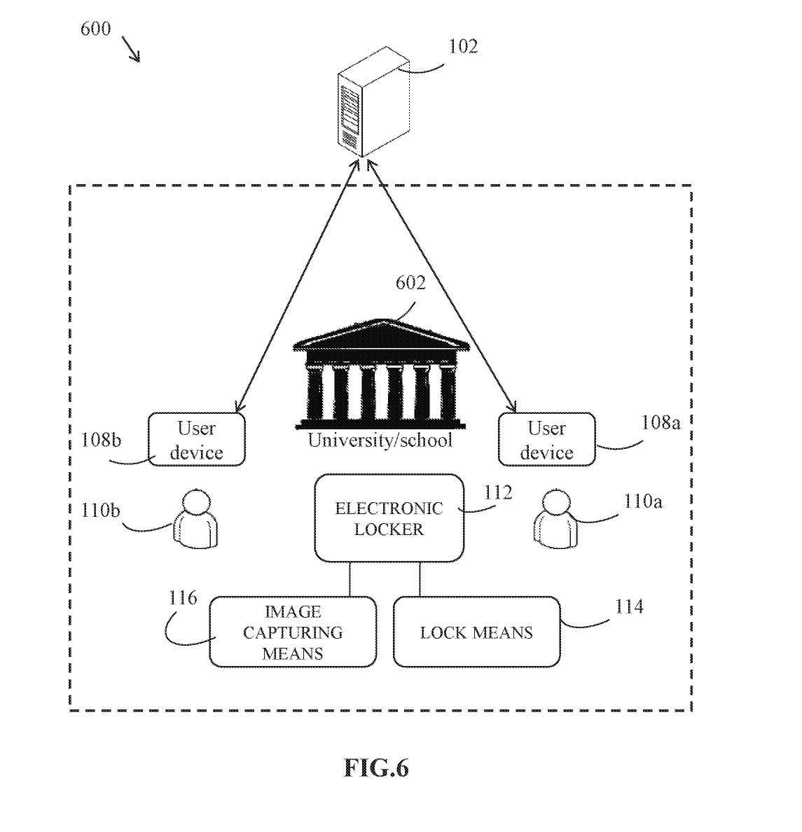

Referring now to FIG. 6 which illustrates an exemplary implementation of the system of FIG. 1, in the field of education, where the users within geo spatial vicinity of one another are enabled to buy or sell or rent or exchange one or more used books, in accordance with an embodiment of the present invention. Particularly, FIG. 6 illustrates an exemplary implementation of the system described above. In the exemplary implementation, the used products are considered to be used books. Conventionally students buy or sell or exchange or rent used books using various online and offline platforms available in the art. However, such conventional methods of buying and selling of used books are not very cost effective as well as inconvenient for the students. Unlikely, the present invention intends to resolve the inefficiency in the existing online and offline systems, by presenting a new method and system that enables students to transact (buy, sell, rent or exchange) the used books and facilitates localized delivery and/or retrieval of the transacted used books without any need of shipping or necessitating the students to move to different locations for collecting and delivering the transacted used books.

In the shown exemplary implementation, the geo location is a specific college or a university 602, where the transacting users 110a, 110b preferably students are present in vicinity of one another. The students 110a, 110b may have the communication devices 108a, 108b associated with them. Whether the students 110a,110b are within the vicinity of one another is determined based on the user related information stored in the databases 104 communicatively coupled to the server 102 as described above in relation to FIG. 1.

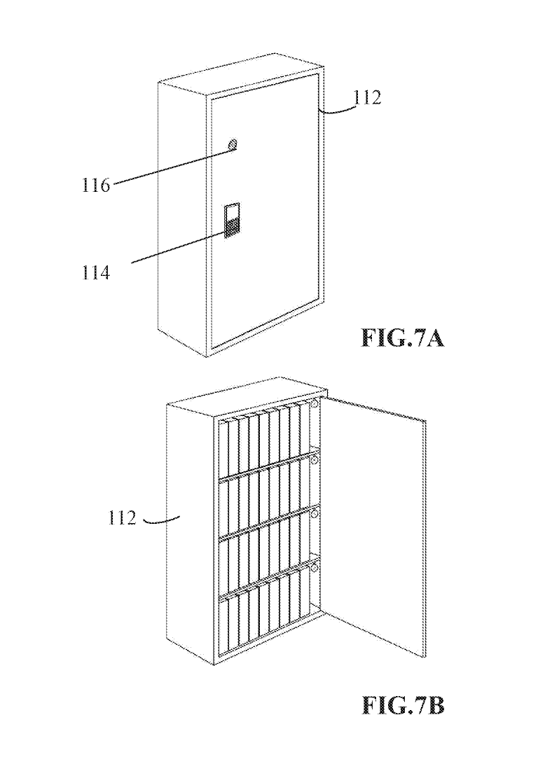

FIG. 6 further shows presence of the electronic locker 112 within the vicinity of the students 110a, 110b. Exemplary representation of the locker 112 in a locked state and an unlocked state respectively is shown in FIGS. 7A-7B. As shown in FIG. 7A, the locker 112 will preferably embody the lock means 114 and one or more image capturing means 116. Further as shown in FIGS. 7A-7B, the locker 112 may embody a single panel door. The locker 112 may be designed to have a plurality of shelves strategically configured inside and spaced apart from each other to form a plurality of receptacles for receiving the used books transacted (bought or sold or exchanged or rented) by the students 110a, 110b which are then delivered and/or are retrieved from the locker 112. The shelves may preferably have some identification indicia related to each of the shelves, for example, a number or name assigned to each of the shelves, for example shelf “A”, shelf “B” and so on.

As described above in relation to FIG. 1, the students belonging to the university or school 602 which are in the geo spatial vicinity can access the web service coupled to the server 102 provided in the form of website or downloadable app using the communication devices 108a, 108b held by students 110a, 110b in order to transact (buy or sell or rent or exchange) any used book listed by the web services.

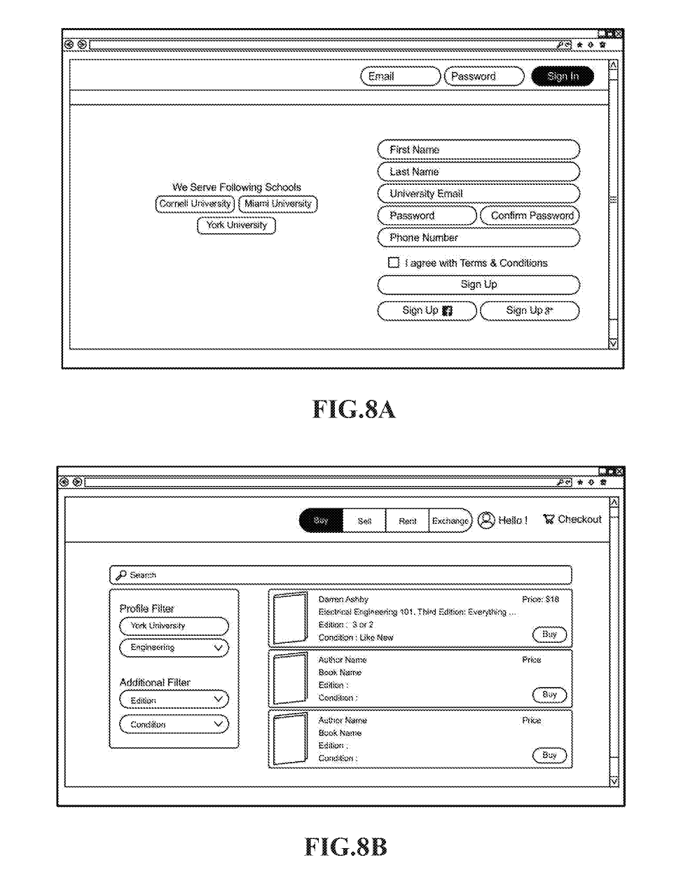

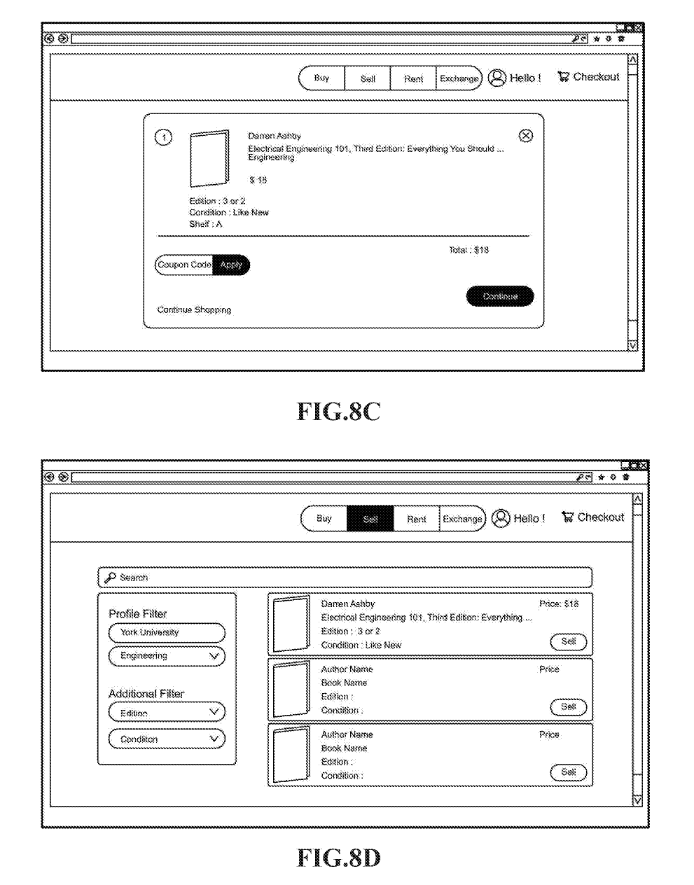

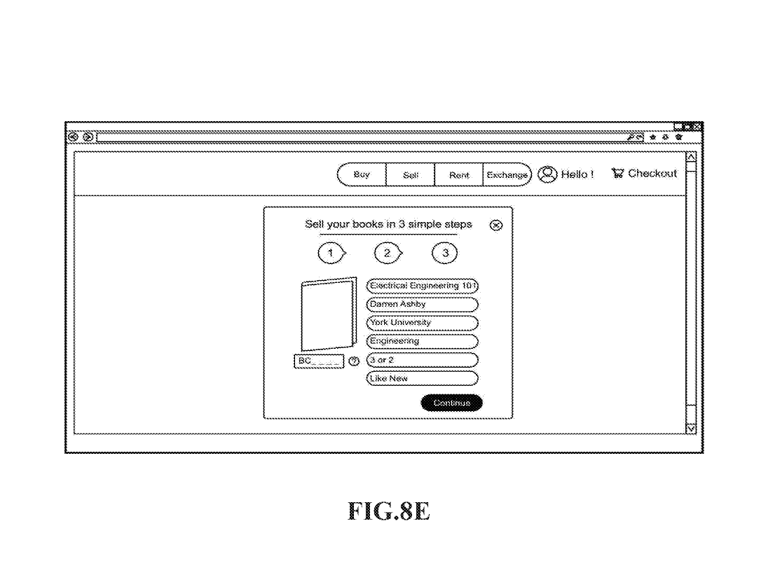

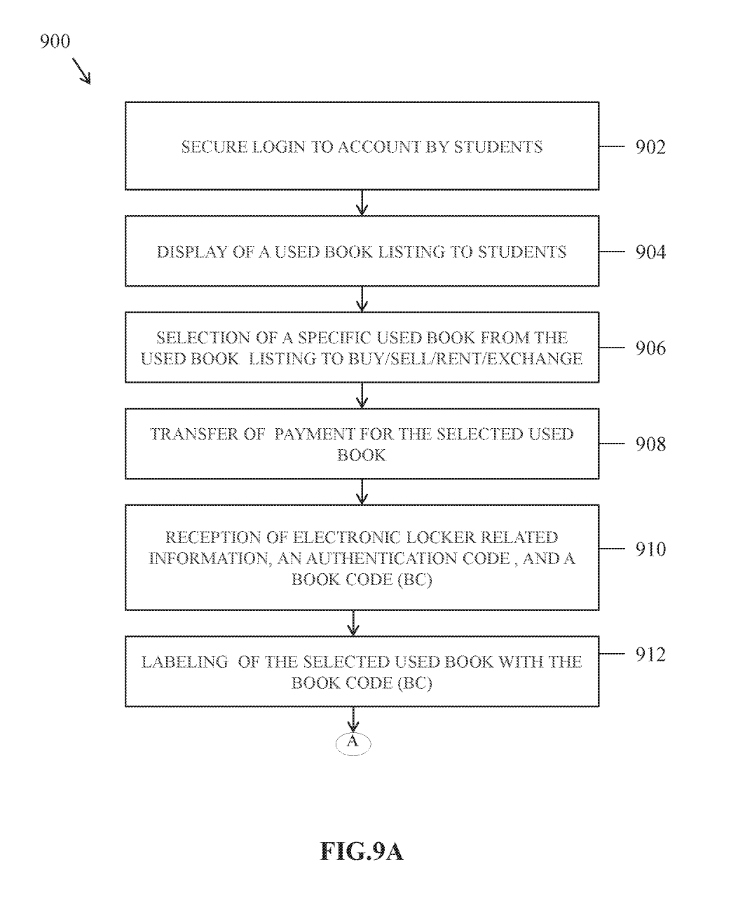

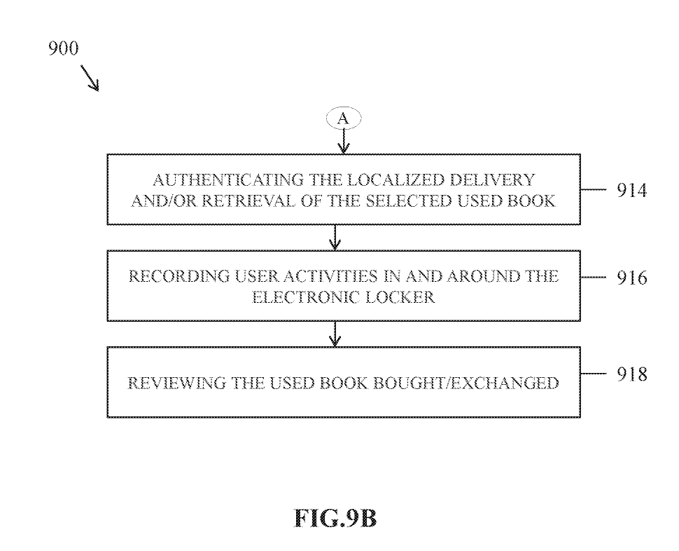

Referring to FIGS. 8A-8E that shows example web pages in conjunction with FIGS. 9A-9B illustrating method steps in relation to the exemplary implementation of system shown in FIG. 6.

As shown in FIG. 8A and FIG. 9A, The students 110a, 110b desirous of transacting used books (for examples buy or sell the used books) can either signup for the web services with the server 102 by providing user related information such as but not limited to first name, last name, email, password, phone number or sign up using Google® or Facebook® Account Or if the students 110a,110b are already registered users having account with the server 102, then the students 110a,110b may directly login to their accounts (step 902) using their login credentials, for example username and password.

As shown in FIG. 8B and FIG. 9A, the students 110a, 110b may have options to buy or sell or exchange or rent the used book. Considering the student 110a or 110b elects/intends to buy a specific used book. The web service will automatically present a used book listing to the student 110a or 110b desirous of buying the used book based on the student related information stored in the database 104 accessible by the server 102. The student 110a or 110b will be presented with the list of used books by the web service (step 904). The transacting student 110a or 110b can select desired used book that he/she intend to buy (step 906). The student 110a or 110b will also have an option to further filter the list of used books displayed to him over the user communication device 108a or 108b. A shown in the example webpage, the student 110a or 110b selects the used book titled “Electrical Engineering 101, Third Edition; Everything . . . ”, author “Darren Ashbey”, Edition: 3 or 2 and condition being new for price 18$.

As shown in FIG. 8C and FIG. 9A, once the student 110a or 110b has made his selection for buying the used book, the student 110a or 110b can then transfer payment for the selected used book using any acceptable payment method (step 908). Optionally, the students may have facility for applying any coupon code if they hold any coupon provided by the web service.

Considering a scenario where, the student 110a, 110b intend to sell a specific used book for example, the book titled “Electrical Engineering 101, Third Edition; Everything . . . ”, author “Darren Ashbey”, Edition: 3 or 2 and condition being new for price 18$., referring to FIG. 8D-8E and FIG. 9A, the student 110a or 110b will be initially presented with the list of used books that web services accepts, and the student 110a or 110b can make a selection as described in steps 904, and 906.

Thereafter, the student 110a or 110b can complete the transaction. while completing the transaction of selling, the student 110a,110b may be prompted to enter a book code (BC) present on the used book he intends to sell (as shown in FIG. 8E), if the book is being sold for the second time, else the student 110a,110b can proceed with the transaction. Once the student completes the transaction, the web service or the server 102 will generate and transmit an electronic locker related information (step 910) that would help the student 110a,110b locate the locker 112 within his vicinity (that's within his college or university 602). The electronic locker related information may include a locker identification number and exact location details of the locker with the college or university 602. Further, the server 102 or web service will generate and provide user authentication code (step 910) to the student 110a, 110b for authorizing the student 110a, 110b to access the electronic locker 112 to deliver or retrieve the books to and from the locker 112. The student 110a, 110b may need to deliver or drop the book into the locker 112 when the student 110a,110b is selling the used book, and may need to retrieve or pick-up the book from the locker 112, when the student 110a,110b has bought the book. The authentication code may be numerical, alphabet or alphanumeric. The server 102 or web service further generate and transmits a book code (BC) (step 910) associated with the used book being sold or exchanged or rented. The term ‘book code’ as used herein is derived from “used product code” used above and is interchangeably used. The book code identifies the used book being transacted. The server 102 may not generate and transmit the book code (BC), in case the used book is being transacted for the second time and the student 110a, 110b would be prompted to enter the BC while selling or renting or exchanging the book. The book code may preferably be in numeral or alphabets or alphanumeric form. The BC, the user authentication code and the electronic locker related information may preferably be transmitted to the student 110a, 110b by the server 102 or the web service via preferably but not limited to SMS, Email, and direct push message.

Referring to FIG. 9A-9B, the step 912 describes labeling of the used book with the BC by the student 110a, 110b before the student 110a, 110b delivers the used book into the electronic locker 112. The labeling of the book is mainly needed during a sell or exchange or rent transactions. The BC helps the web services to authenticate or audit the transactions of the student 110a, or 110b and manage the inventory of the books stored in the electronic locker 112.

The step 914 describes authenticating, the localized delivery and/or retrieval of the used book to and from the electronic locker 112 by the student 110a or 110b using the user authentication code received from the server 102 to complete the transaction.

The step 916 describes recordation of one or more user/student activities in and around the electronic locker 112 by the image capturing means 116. The user activities may relate to the activities of the registered students 110a, 110b having account with the server 102 or activities related to unregistered users/students (non account holder). The activities of the registered students may preferably be delivery and/or retrieval of the books to and from the electronic locker 112, theft or vandalism related activities of the books stored in the electronic locker 112. The activities of the unregistered users/students may preferably be theft or vandalism related activities of the books stored in the electronic locker 112.

The step 918 describes reviewing the used book during or after transaction (bought or exchanged) by the student 110a, 110b using the BC associated with the used book and labeled thereon. The reviewing facilitates the web service in managing the inventory of the used books stored in the electronic locker 112.

While for purposes of simplicity of explanation, the illustrated blocks are shown and described as a series of method steps, it is to be appreciated that the methodologies are not limited by the order of the blocks, as some blocks can occur in different orders and/or concurrently with other blocks from that shown and described. Moreover, more or less in number than all the illustrated blocks may be required to implement an example system and methodology described above. Blocks may be combined or separated into multiple components. Furthermore, additional and/or alternative methodologies can employ additional, not illustrated blocks.

In the foregoing description, certain terms have been used for brevity, clearness, and understanding. No unnecessary limitations are to be implied there from beyond the requirement of the prior art because such terms are used for descriptive purposes and are intended to be broadly construed. Therefore, the disclosure is not limited to the specific details, the representative embodiments, and illustrative examples shown and described. Thus, this application is intended to embrace alterations, modifications, and variations that fall within the scope of the current disclosure

What is claimed is:

1. A method for facilitating one or more users to transact one or more used products, and enabling localized delivery and/or retrieval of the product by ensuring that transacting users are present in the geo-spatial vicinity of one another, the method comprising:
a. receiving, one or more user related information, from each of the users by an application server with one or more databases for creation of a user account, and storage of the one or more user related information in the one or more databases;
b. allowing, each of the users to securely login to the user account using a user communication device communicatively coupled with the application server;
c. displaying, a used product listing to each of the users over the user communication device by the application server based on the one or more user related information stored in the one or more databases, wherein the display of the used products listing may selectively be initiated by the user using a search query consisting of one or more information associated with the used products;
d. selecting, a specific used product from the used product listing displayed over the user communication device by the user for transaction;
e. transferring payment, for the selected used product selected for transaction by the user using the user communication device communicatively coupled with the application server;
f. generating and transmitting, by the server at least one of:
an electronic locker related information associated with an electronic locker with one or more image capturing means configured within the geo-spatial vicinity of the user, wherein the electronic locker related information is generated and transmitted based the on the one or more user related information stored in the one or more databases;
a user authentication code for authorizing the user to securely access the electronic locker configured within the geo-spatial vicinity of the user and to enable the localized delivery and retrieval of the selected used product to and from the electronic locker; and
a Used Product Code (UPC) associated with the selected used product, wherein the generation of the Used Product Code (UPC) identifying the selected used product is accomplished during the transaction request from the user;
g. labeling, the selected used product, with the Used Product code (UPC) by the user before delivering the selected used product into the electronic locker;
h. authenticating, the localized delivery and/or retrieval of the selected used product to and from the electronic locker by the user using the user authentication code to complete the transaction of the selected used product;
i. recordation of one or more user activities in and around the electronic locker by the image capturing means; and
j. reviewing, the selected used product during or after transaction by the user using the Used Product Code (UPC) associated with the selected used product and labeled thereon, wherein the steps of labeling, and reviewing facilitate in managing an inventory of the used products stored in the electronic locker.

2. The method of claim 1, wherein the one or more user related information comprising at least one of: a username, a password, an address associated with the user, an email address, a telephone number, academic related information associated with the user, profession related information associated with the user, and preferred interests of the user.

3. The method of claim 1, wherein the one or more information associated with the used product comprising at least one a physical condition of the used product, a manufacturing year, a publication version.

4. The method of claim 1, wherein the electronic locker related information comprising at least one location information associated with the electronic locker, a locker identification number associated with the electronic locker.

5. The method of claim 1, wherein the user authentication code comprising at least one numeral, alphabet or alpha numeral code.

6. The method of claim 1, wherein the Used Product code (UPC) associated with the used product comprising at least one numeral, alphabet or alpha numeral code.

7. The method of claim 1, wherein the electronic locker including a lock means configured to be digitally controlled using a key pad, be electro-magnetically controlled, be manually controlled using a key accessible electronically or be wirelessly controlled using wireless technologies conventionally known which when operated by the user using the user authentication code provide a secure access to the user to deliver and/or retrieve the used product therefrom.

8. The method of claim 1, wherein the one or more image capturing means comprising at least one of: a digital camera, and a video camera.

9. The method of claim 1 further comprising a step of prompting the user to enter the Used Product Code (UPC) associated with the selected used product and labeled thereon when the user transacts the selected used product next time.

10. The method of claim 1, wherein the one or more user activities including delivery and/or retrieval of the selected used product to and from the electronic locker by the user, activities associated with theft or vandalism of the used products stored in the electronic locker by the user or other users not having the user account.

11. A system for facilitating one or more users to transact one or more used products, and enabling localized delivery or retrieval of the one or more used product by ensuring that the transacting users are present in geo-spatial vicinity of one another, the system comprising:
a. an application server including one or more databases, wherein the server is communicatively coupled to a user communication device associated with each of the one or more users;
b. an electronic locker configured within the geo-spatial vicinity of the user for storage of the used products and enabling the localized delivery and/or retrieval of the used product to and from the electronic locker;
c. one or more image capturing means associated with the electronic locker for recordation of one or more user activities in and around the electronic locker;
d. a web service coupled to the application server and having associated software application accessible by the user over the user communication device, wherein the web service of the server accessible by the user functions to:
receive one or more user related information, from each of the users for creation of a user account and storage of the one or more user related information into the one or more databases associated with the application server;
allow, each of the users to securely login to the user account using the user communication device communicatively coupled with the application server;
display, a used product listing to each of the user over the user communication device based on the one or more user related information stored in the one or more databases, wherein the display of the used product listing may selectively be initiated by the user using a search query consisting of one or more information associated with the used products;
enable the user with selection of a specific used product from the used product listing displayed over the user communication device for transaction;
enable the user to transfer payment, for the selected used product for transaction using the user communication device; and
generate and transmit at least one of: an electronic locker related information associated with the electronic locker, wherein the electronic locker related information is generated and transmitted based the on the one or more user related information stored in the one or more databases; a user authentication code for authorizing the user to securely access the electronic locker and enable the localized delivery and retrieval of the selected used product to and from the electronic locker; and a Used Product Code (UPC) associated with the selected used product, wherein the generation of the Used Product Code (UPC) identifying the selected used product is accomplished during the transaction request from the user.

12. The system of claim 11, wherein the Used Product code (UPC) generated and transmitted to the user transacting the product for labeling the selected used product with the Used Product code (UPC) before delivering the selected used product into the electronic locker.

13. The system of claim 12, wherein the Used Product code (UPC) labeled on the selected used product enable the user transacting the product to share review on the selected used product.

14. The system of claim 12, wherein the Used Product code (UPC) may further be available and readily labeled on the selected used product when the user transact for the selected used product next time.

15. The system of claim 11, wherein the one or more user related information comprising at least one of: a username, a password, an address associated with the user, an email address, a telephone number, academic related information associated with the user, profession related information associated with the user, and preferred interests of the user.

16. The system of claim 11, wherein the one or more information associated with the used product comprising at least one a physical condition of the used product, a manufacturing year, a publication version.

17. The system of claim 11, wherein the electronic locker related information comprising at least one a location information associated with the electronic locker, and a locker identification number associated with the electronic locker configured within the geo-spatial vicinity of the user.

18. The system of claim 11, wherein the electronic locker including a lock means configured to be digitally controlled using a key pad, be electro-magnetically controlled, be manually controlled using a key accessible electronically or be wirelessly controlled using wireless technologies conventionally known which when operated by the user using the user authentication code provide a secure access to the user to deliver and/or retrieve the used product therefrom.

19. The system of claim 11, wherein the user authentication code, and the Used Product code (UPC) comprising at least one numeral, alphabet or alpha numeral code.

20. The system of claim 11, wherein the one or more user activities including delivery and/or retrieval of the selected used product to and from the electronic locker by the user, activities associated with theft or vandalism of the used products stored in the electronic locker by the user or other users not having the user account.
